(19) United States
(12) Patent Application Publication
(10) Pub. No.: US 2008/0099258 A1
(43) Pub. Date: May 1, 2008

(54) Vented sealed housing assembly for vehicle powertrain

(76) Inventor: Michael T. Berhan, Sylvania, OH (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/586,815

(22) Filed: Oct. 26, 2006

(51) Int. Cl. B60K 6/00

(52) U.S. Cl. 180/65.2; 310/54

(57) ABSTRACT

A system for venting a sealed, enclosed volume in the powertrain of an automotive vehicle includes a first housing, a second housing mechanically connected to the first housing, the first and second housings enclosing a volume, a seal located at an interface between the first and second housings for sealing said volume against passage of fluid; and a hollow vent tube having a length and including a first end communicating with the volume, and a second end spaced along the length from the first end, the second end permitting pneumatic fluid to enter and leave the vent tube.

### BACKGROUND OF THE INVENTION

1. Field of the invention

This invention relates generally to an apparatus for venting air from a sealed housing containing components of a hybrid electric vehicle powertrain.

2. Description of the Prior Art

In a motor vehicle powertrain, various housings are interconnected at bolted connections, such as where a transmission housing, which contains hydraulic controls and actuation components, gearing, shafts, servos, clutches and brakes, is mechanically connected to an engine block. Transmission housings, for example, may be vented to the atmosphere to prevent differential air pressure across the seals located the housing interface connections. Such venting of the transmission housing is typically located in the main part of the transmission case on the opposite side of the pump body from the location of the bell housing, which contains a torque converter.

Hybrid electric vehicle powertrains include motor/generator assemblies, which can be located in the bell housing. These assemblies include the rotor and stator of the electric machine that drives the vehicle wheels in combination with an internal combustion engine (ICE). Cooling and lubricating the stator, rotor, bearings, and related components in a vehicle powertrain that includes an ICE, an integrated starter generator (ISG), and transmission, especially one that requires the powertrain to be partially or fully submersible, requires good sealing and preferably both an independent lubrication system and an elevated air vent to accommodate thermal expansion and contraction of hydraulic lubricant and air within the housing.

When the temperature of air in an enclosed, sealed container rises relative to the ambient temperature of the external environment, its expansion creates a differential pressure, which can cause failure of the seals located at metal-to-metal interfaces between adjoined portions of the container. Depending on the temperature and pressure differentials and the pressure resistance capacity of the seals, air pressure alone can cause the seals to become dislodged or have local breaks in their continuity, thereby permitting fluids located in the housing to flow past the sealed interfaces. When increasing temperature of hydraulic lubricant in the sealed container occurs concurrently with its effect on air in the container, their combined expansion increases the risk of seal failure.

There is a need, therefore, for a fluid tight, hermetically sealed, vented assembly of housings in a hybrid electric vehicle powertrain that will perform satisfactorily when submerged in a hydraulic fluid, such as automatic transmission fluid (ATF), water or another fluid.

### SUMMARY OF THE INVENTION

A system for venting a sealed, enclosed volume in the powertrain of an automotive vehicle includes a first housing, a second housing mechanically connected to the first housing, the first and second housings enclosing a volume, a seal located at an interface between the first and second housings for sealing said volume against passage of fluid; and a hollow vent tube having a length and including a first end communicating with the volume, and a second end spaced along the length from the first end, the second end permitting pneumatic fluid to enter and leave the vent tube.

The system permits a vehicle powertrain to be submersed in hydraulic fluid to a depth that will not compromise safety and operation of the powertrain. The system permits the submersion function to be realized in low volume applications using add-on components in a powertrain that is in production instead of requiring a redesign of existing transmissions, transfer cases, differential mechanisms, etc.

A hermetically sealed and vented housing or multiple housings around a motor/generator and the interfacing powertrain components is used with lubrication. To avoid damage to the seals at the interface between housing components caused by pressure in the sealed volume within the housing, a hollow vent tube having one end open to the atmosphere and the opposite end communicating with the interior volume of the housing may be used.

A sealed air bladder may be used if venting to the atmosphere is not desired. An accumulator in the form of a flexible bladder can be located below the submersion depth specification of the motor vehicle, provided the bladder is sealed.

The bladder can have a small volume, whose size is matched in respect of its elastic expansion and contraction to the anticipated pressure changes in the sealed volume bounded by the housing.

Preferably the seal used at the housing interface is tolerant of high temperatures and corrosive liquids, such as salt water. The seal should accommodate hydraulic and electric connections that cross the boundaries of the housing to the external environment.

The venting system may be utilized with units anywhere in the powertrain, such as around motor/generators, between an engine and transmission, in a transfer case, or in a driveline or axle unit.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

These and other advantages will become readily apparent to those skilled in the art from the following detailed description of a preferred embodiment when considered in the light of the accompanying drawings in which:

FIG. 1 is a cross section illustrating a first embodiment of a drive system apparatus;

FIG. 2 is schematic diagram showing a vent tube connecting a sealed volume in FIG. 1 to atmosphere;

FIG. 3 is a schematic diagram showing a vent tube connecting the sealed volume to an accumulator; and

FIG. 4 is a top view of a motor vehicle driveline that includes a transmission, transfer case, and rear differential or axle housing; and

FIG. 5 is side view of a jiggle cap.

### DESCRIPTION OF THE PREFERRED EMBODIMENT

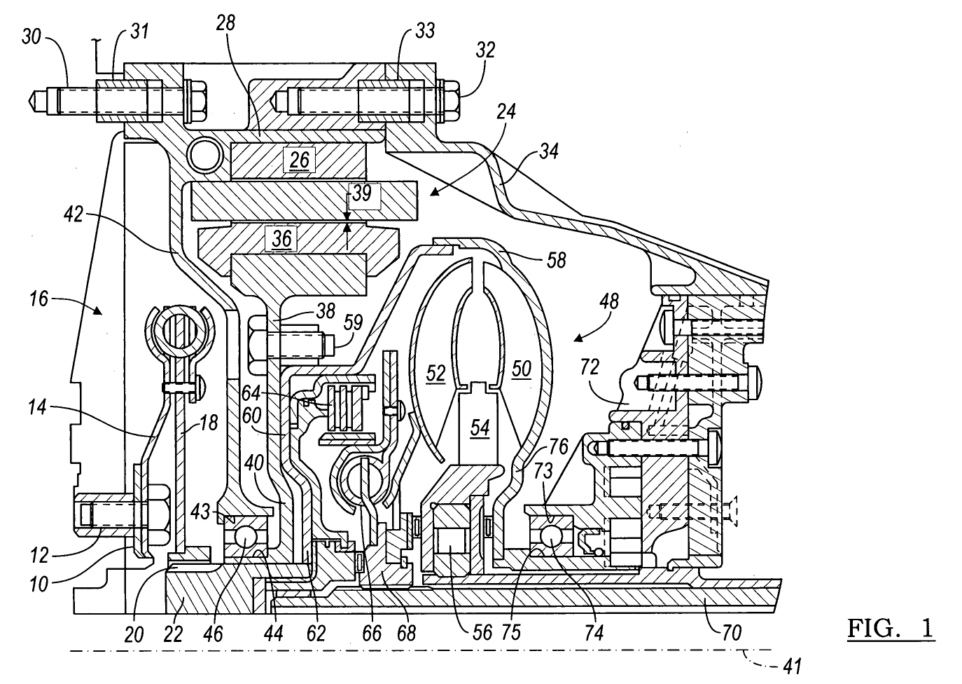

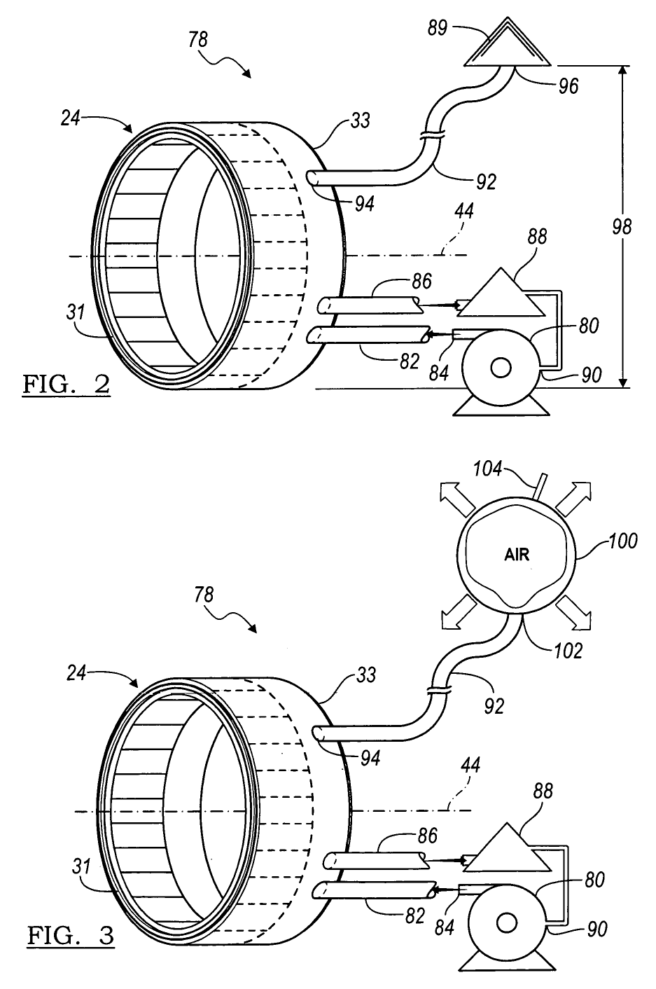

Referring first to FIG. 1, a first power source, such as an internal combustion engine, includes an engine crankshaft 10, which is connected by bolts 12 and a flex plate 14 to a torsion damper 16, whose output 18 is driveably connected through a spline 20 to a shaft 22.

A second power source, an electric machine 24, includes a stator 26 secured to a housing 28, which is secured by a series of bolts 30 to the engine rear face of an engine block, and by a series of bolts 32 to a transmission housing 34. Fitted in aligned recesses at the interface between housing 28 and the engine block is a fluid-tight, hermetic seal 31, located on the parting plane between adjacent housings and which is compressed by torque applied to bolts 30. Also fitted in aligned recesses at the interface between housing 28 and transmission housing 34 is a fluid-tight, hermetic seal 33 located on the parting plane between adjacent housings and which is compressed by torque applied to bolts 32. Housing 28, 34 and the engine block provide an assembly of sealed and mechanically interconnected housings, which contain an electric machine 24, a torque converter 48 and other components of the powertrain.

The electric machine 24 includes a rotor 36, which is supported on a disc member 38 such that the radial outer surface of the rotor stator is spaced a short distance 39 from the radial inner surface of a stator 26, which is secured to and supported on housing 28. The rotor and other rotating components of the drive system rotate about an axis 41. The disc member 38 includes a hub 40, which is supported on and secured to shaft 22. The housing 28 of the electric machine 24 includes a stationary disc member 42, which is secured at its radial outer end by bolt 30 to the engine and is formed at its radial inner end with a pilot surface 43. The hub 40 of disc member 38 is also formed with a pilot surface 44. A first bearing 46, located at the axial forward side of torque converter 48, engages the pilot surfaces 43, 44 and supports shaft 22 and rotor 36 as they rotate about axis 41 on the transmission housing 34.

A torque converter 48 includes a bladed impeller wheel 50, a bladed turbine wheel 52, and a bladed stator wheel 54, which is supported on a one-way clutch 56. The torque converter 48 includes a casing 58, which encloses the impeller 50, turbine 52, and stator 54 and extends axially toward the disc member 38. A bolt 59 can be used to connect mutually the casing 58 and member 38, or they can be mutually secured at 60. The radial inner end of cover 58 is secured at 62 to shaft 22.

A bypass clutch 64 and torsion damper 66 are located within the torque converter case 58. The bypass clutch 64, which includes an input secured to the case 58 and an output secured to the turbine wheel 52 and damper 66, alternately opens and closes a drive connection between the case 58 and turbine wheel 52. When bypass clutch 64 is engaged, a direct mechanical connection between shaft 22 and a transmission input shaft 70 is produced, thereby bypassing the hydrokinetic connection produced by the torque converter 48 when clutch 64 is disengaged. The torsion damper 66 includes an output secured to a turbine wheel hub 68, which is splined to input shaft 70.

A pump body 72, secured to the transmission case 34, is formed with a third pilot surface 73. The hub 76 of the impeller case 58 is formed with a fourth pilot surface 75. A second bearing 74, located at the axial rearward side of torque converter 48, engages pilot surfaces 73, 75 and supports converter case 58 on the transmission housing 34 as it rotates about axis 41.

The kinematic assembly, hydraulic actuation system and electronic controls of an automatic transmission are located at the right-hand side, i.e., rearward, of the oil pump body 72.

The electric machine 24 and torque converter 48 require fluid for cooling and lubrication. Therefore, a system 78 for supplying, recovering and recirculating hydraulic fluid for the powertrain equipment and for preventing leakage of fluids across the housing interfaces is required. FIG. 3 illustrates a hydraulic pump 80, a fluid supply line 82 connected to the pump outlet 84 and then leading to the electric machine 24, and a fluid return line 86 carrying fluid collected at the base of the electric machine to a sump 88 from which fluid enters the pump inlet 90. Fluid exiting supply line 82 can be sprayed onto the surfaces of the stator 26 and rotor 36 or the fluid can be allowed to collect in a pool at the lowest elevation of the electric machine 24, where rotation of the rotor draws fluid from the pool and splashes it against the stator. Fluid from the stator and rotor returns to the pool and reenters the fluid return line 86 for recirculation to the sump 88 and pump 80. Alternately, the rotor 36 and stator 26 can be enclosed in an oil jacket, which is continually supplied with fluid lubricant or coolant from the pump outlet 84 To prevent differential pressure across the hermetic seals 31, 33, a snorkel tube or vent tube 92 has one end 94, located in the sealed housings 28, 34, and another end 96, located at an elevation 98 above, or at least at the elevation specified in the submersion or fording specification of the vehicle in which the system 76 is employed. End 96 communicates with the atmosphere. The submersion or fording specification of the vehicle indicates the maximum depth above the elevation where the wheels contact the road surface, to which the vehicle can be driven without incurring harm to its electrical system or other systems, such as would stall the engine, wet the electric drive and control system, or otherwise jeopardize the function or structure of the vehicle due to entry of hydraulic fluid into the vehicle.

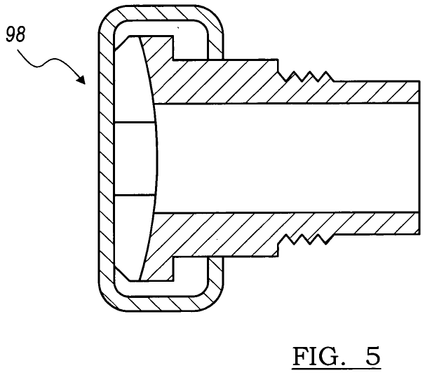

The vent tube end 96 is covered, by not sealed by a jiggle cap 89, which allows pneumatic fluid to enter and leave tube 92, but prevents hydraulic fluid from entering and leaving the tube, as illustrated in FIG. 5. The preferred cap 89 is also know by the following and other terms “crimped vent cap”, “vent” “loose, retained vent”, “breather”, “breather cap”, “right angle vent”, “transmission vent assembly”, or other names can be, and are, used. Alternately the cap 89 can be replaced by waterproof, air-venting artificial fiber cloths and other semi-permeable materials, such as GORE-TEX®. Suitable materials of this kind prevent passage of non-pressurized liquid and fine dust, but they permit pressurized air to pass through.

FIG. 3 illustrates an alternate embodiment of the system 78, in which a sealed air bladder or another accumulator 100 may also be used, if venting of the housings 28, 34 to the atmosphere is not desired. In FIG. 3, differential pressure across the hermetic seals 31, 33, is prevented by extending the vent tube 92 from its first end 94, located in the sealed housings 28, 34, to a second end 102, which communicates with the pneumatic accumulator 100. Preferably pressure in accumulator 100 is substantially equal to atmospheric pressure at the location of the vehicle.

If the accumulator 100 is a flexible bladder, its internal pressure will change in response to ambient atmospheric pressure and temperature because its volume will expand and contract. The elastic expansion and contraction of the bladder accumulator 100 is preferably matched to the anticipated pressure change of the sealed volume within the housings 28, 34 due to temperature changes in the volume of pneumatic fluid and hydraulic fluid enclosed by and sealed in the housings.

If the accumulator 100 is a canister with inflexible walls, a pressure regulation valve 104 may be provided to maintain its internal pressure equal to or within an acceptable range of atmospheric pressure.

Accumulator 100 can be located below the submersion depth specified for the vehicle, provided the accumulator is sealed.

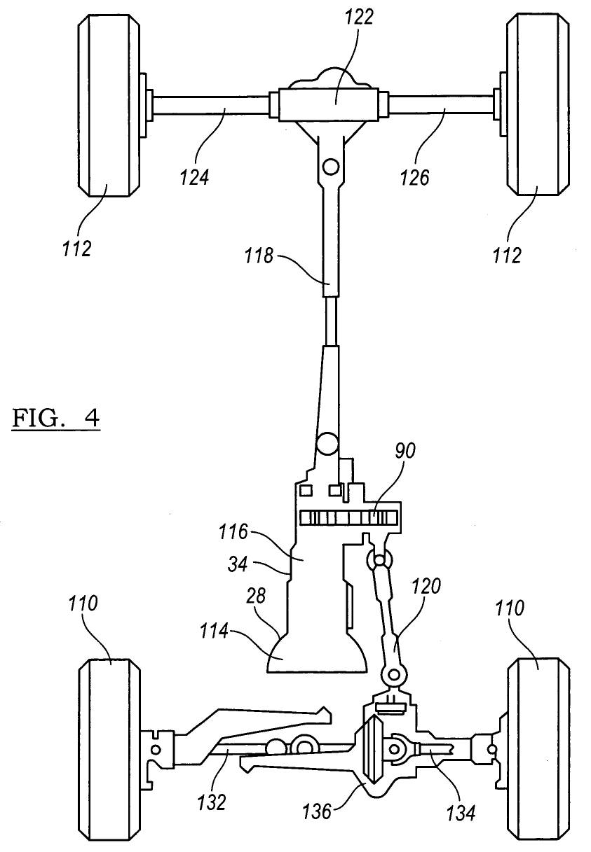

FIG. 4 illustrates the powertrain of a motor vehicle that includes various sealed, interconnected housings to which the present invention can be applied. The powertrain includes front and rear wheels 110, 112, a power transmission housing having its components located in transmission housing 34 and bell housing 28, produces multiple forward and reverse speed ratios driven by an engine (not shown). A transfer assembly having its components located in a transfer case 116 continuously driveably connects the transmission output to a rear drive shaft 118. The transfer assembly 116 selectively connects the transmission output to both the front drive shaft 120 and rear drive shaft 118 when a four-wheel drive mode of operation is selected. Shaft 118 transmits power to a rear wheel differential mechanism located in a housing 138, from which power is transmitted differentially to the rear wheels 112 through axle shafts 124, 126, which are contained within the differential housing 138. The front wheels are driveably connected to right-hand and left-hand halfshafts 132, 134, to which power is transmitted from the front drive shaft 120 through a front differential mechanism located in a housing 136.

The transfer assembly continually transmits rotating power to the rear driveshaft 118 and rear wheels 112, which is the primary power path. The transfer assembly intermittently transmits rotating power to the front driveshaft 120 and the front wheels 110, which is the secondary power path, when a clutch, located in the transfer case 116 is actuated.

In addition to the sealed housing interfaces shown in FIG. 1 between the engine block and bell housing 28 and between bell housing 28 and transmission housing 34, other sealed housing interfaces, such as those between the transmission housing 34 and transfer case 116, between the rear differential housing 138 and its rear cover, and between portions of the front differential mechanism housing 136, can be vented by the technique described here.

In accordance with the provisions of the patent statutes, the preferred embodiment has been described. However, it should be noted that the alternate embodiments can be practiced otherwise than as specifically illustrated and described.

What is claimed is:

1. Apparatus for venting a sealed, enclosed volume in the powertrain of an automotive vehicle, comprising:
a first housing;
a second housing mechanically connected to the first housing, the first and second housings enclosing a volume;
a seal located at an interface between the first and second housings for sealing said volume against passage of fluid; and
a hollow vent tube having a length and including a first end communicating with the volume, and a second end spaced along the length from the first end, the second end permitting pneumatic fluid to enter and leave the vent tube.

2. The apparatus of claim 1 further comprising:
a device communicating with the second end for permitting pneumatic fluid to enter and leave the vent tube and preventing hydraulic fluid to enter and exit the vent tube.

3. The apparatus of claim 1 wherein said device is a jiggle cap secured to the second end.

4. The apparatus of claim 1 wherein the second end is located at an elevation that is equal to or greater than an elevation to which the motor vehicle is permitted to become submerged in a hydraulic fluid.

5. The apparatus of claim 1 further comprising:
a supply line for carrying hydraulic fluid into the volume;
a return line for carrying hydraulic fluid from the volume;
a sump communicating with the return line for containing fluid carried to the sump in the return line; and
a hydraulic pump including an outlet communicating with the supply line and an inlet communicating with the sump.

6. The apparatus of claim 1 further comprising:
an electric machine located in the volume and including a stator and a rotor;
a supply line for carrying hydraulic fluid to the electric machine such that at least one surface of the rotor and stator is wetted by the hydraulic fluid;
a return line for carrying hydraulic fluid from the electric machine;
a sump communicating with the return line for containing fluid carried to the sump in the return line; and
a hydraulic pump including an inlet communicating with the sump and an outlet communicating with the supply line for pumping fluid from the inlet to the outlet.

7. A system for venting a sealed, enclosed volume in the powertrain of an automotive vehicle, comprising:
a first housing;
a second housing mechanically connected to the first housing, the first and second housings enclosing a volume;
a seal located at an interface between the first and second housings for sealing said volume against passage of fluid; and
a hollow vent tube having a length and including a first end communicating with the volume, and a second end spaced along the length from the first end; and
an accumulator for containing fluid, including walls that enclose a second volume that communicates with the vent tube through the second end.

8. The system of claim 7 wherein the accumulator further comprises:
an accumulator having flexible walls enclosing the second volume, the second volume expanding and contracting in response to a magnitude of pressure within the second volume.

9. The system of claim 7 wherein the accumulator further comprises:
an accumulator having inflexible walls enclosing the second volume, the second volume being unable to expand and contract in response to a magnitude of pressure within the second volume.

10. The system of claim 7 wherein the second volume is located at an elevation that is equal to or greater than an elevation to which the motor vehicle is permitted to become submerged in a hydraulic fluid.

11. The system of claim 7 further comprising:
a supply line for carrying hydraulic fluid into the volume;
a return line for carrying hydraulic fluid from the volume;
a sump communicating with the return line for containing fluid carried to the sump in the return line; and
a hydraulic pump including an outlet communicating with the supply line and an inlet communicating with the sump.

12. The system of claim 1 further comprising:
an electric machine located in the volume and including a stator and a rotor;
a supply line for carrying hydraulic fluid to the electric machine such that at least one surface of the rotor and stator is wetted by the hydraulic fluid;
a return line for carrying hydraulic fluid from the electric machine;
a sump communicating with the return line for containing fluid carried to the sump in the return line; and
a hydraulic pump including an inlet communicating with the sump and an outlet communicating with the supply line for pumping fluid from the inlet to the outlet.
